(19) United States
(12) Patent Application Publication
(10) Pub. No.: US 2023/0316942 A1
(43) Pub. Date: Oct. 5, 2023

(54) TRAINING SYSTEM WITH PERSONALIZED, EFFECTIVE, ASYNCHRONOUS AND REMOTE FEEDBACK

(71) Applicant: TRAINING COMPETENCE SPA., Santiago de Chile (CL)

(72) Inventors: Julian Emanuel VARAS COHEN, Santiago de Chile (CL); Gabriel Enrique ESCALONA VIVAS, Santiago de Chile (CL)

(21) Appl. No.: 17/708,676

(22) Filed: Mar. 30, 2022

(51) Int. Cl. G09B 5/06; G09B 7/02

(52) U.S. Cl. CPC G09B 5/06; G09B 7/02

(57) ABSTRACT

Training systems and methods with personalized, effective, asynchronous, and remote feedback facilitate the transfer of skills from a user or groups of users with the profile of teacher(s) or evaluator(s) or expert(s) to a user or group of users with a pupil(s) or apprentice(s) or student(s) profile, remotely and asynchronously, allowing learner users or students to acquire competencies by achieving impressive learning curves based on the feedback of the experts(s) and subsequent correction of the errors as they occur. The systems include four parts: (a) a student user module; (b) storage module; (c) a control module; and (d) evaluator module.

### TECHNICAL FIELD

This technology relates to an electronic training and performance evaluation systems. More specifically, the technology relates to training systems and methods with personalized, effective, asynchronous, and remote feedback that facilitate the transfer of skills from user groups with the profiles of teachers or evaluators or experts to a user group with the profiles of pupils or apprentices or students, remotely and asynchronously.

### BACKGROUND

It is essential that professionals receive adequate and effective training, so as to achieve optimal performance at their jobs. Within the variety of possible training, teaching psychomotor or manual skills is a challenge in itself, since it is not enough to teach the theory of certain specific techniques, but it is essential that professionals train and perfect these practical skills ideally until achieving a learning curve. That is why students who are being trained to be professional technicians or higher education professionals such as surgeons, dentists, kinesiologists, nurses or any other profession that requires training in practical and/or technical and/or manual skills (such as gastronomy, musicians, and military among other professions) need to practice constantly and continuously over time to improve their skills and perform at the highest levels in their respective disciplines.

However, students during their professional training are not subjected to constant training sessions due to different problems. One of them is related to the lack of equipment necessary for each of the students to spend a large amount of time training their skills, this being a frequent problem in some educational institutions. However, the main problem is related to having a teacher who is an expert in these techniques, who will provide feedback to students in a timely manner about their performance. On certain occasions during the learning process, it is possible to find a professional expert in a particular technique who can directly deliver feedback to their students, but in most cases this is not what happens, due to the difficulty of getting experts to be physically present at the moment when the practical activities are occurring. Teachers do not always have time available to be with their group of learners at the same time. On the other hand, being an expert in a discipline or skill does not mean that the person is a good teacher. A good teacher is one who best manages what his students learn and requires training in, for example, knowing how to deliver feedback.

That is why different platforms have been developed in the state of the art that make available different courses to which students can access remotely. However, e-learning platforms such as Coursera, Udemy, AIison, and others, are focused on knowledge and deliver useful knowledge in different areas but are not focused on “doing” and on teaching useful manual skills for different professions. For example: sending a book or video to a student teaching the theory of how the guitar is played does not ensure that the student can effectively play guitar.

In the state of the art it is possible to find synchronous and asynchronous remote teaching systems. Some studies indicate that, to obtain the best performance in a workout, direct and immediate feedback is necessary (Ericsson, K. A. (2006). The Influence of Experience and Deliberate Practice on the Development of Superior Expert Performance). However, synchronous and direct feedback poses some problems in the learning process because it is based on instructions for motion corrections (motor) that the student must exercise, not being feasible in courses of numerous students and in sessions limited in time. In addition, in synchronous or face-to-face models, there is no recording of the training, which adds the requirement of the availability of teachers, which is usually restricted to a few hours per week in case of being synchronous; which forces students to adapt to their teachers.

Due to these shortcomings of synchronous and face-to-face remote teaching systems, some asynchronous and remote skills teaching systems have been developed. One of them is TELMA (Sanchez-Gonzalez, P., et al. (2013). TELMA: Technology-enhanced learning environment for minimally invasive surgery. Journal of Surgical Research, 182(1)), which is a platform to improve learning in the area of medicine. Unlike the present invention, with TELMA, problems arose with the editing tools delivered, where feedback was delivered in two formative ways: delivering errors to students and correcting them; and summative, reporting the final score.

Even more significant with respect to the scope and resolution of problems of the present invention, it has been shown that during the COVID-19 pandemic it has allowed training courses to be maintained (Vera, Magdalena et al. Implementation of Distance-Based Simulation Training Programs for Healthcare Professionals, Simulation in Healthcare: The Journal of the Society for Simulation in Healthcare: Jan. 27, 2021; Vera M, et al. Implementation of Distance-Based Simulation Training Programs for Healthcare Professionals: Breaking Barriers During COVID-19 Pandemic. Simul Healthc. 2021 Jan. 27;

The common problem in each of these teaching systems is that not everyone has feedback from an expert or experts or peers: some only deliver the audio-visual material, and others deliver static feedback based on exams and their results. Nor is there the option for groups of teaching users to evaluate groups of students or for an AI to detect errors and then automatically correct students.

Additionally, and to better illustrate the scope of the present invention, a brief review of patents in relation to this technical field is presented below.

CN110503867A describes a method and a system of processing didactic content, focused on the elaboration of virtual micro classes that are visited by students, however, the form of delivery of feedback with all the advantages that the present invention presents is not described.

CN108305516A describes a distance education system where the system comprises the following steps: (1) preparation of teaching materials; (2) online teaching process; (3) cooperation and exchange; (4) online allocation system; (5) online examination application system. This system is focused on the development of professional and recreational skills; however, it does not disclose the advantages of the present invention with respect to asynchronous feedback to students.

CN107341979A describes a miniature virtual reality educational computer system. The miniature virtual reality education computer system consists of a client terminal, a virtual education platform and a database layer; the client terminal can log in to a remote education platform in teacher, student, and administrator roles; and a virtual teaching system is used, however, it does not describe the advantageous features of the present invention that allow for detailed feedback with instructions on how to improve technique.

CN106710336A describes a networked teaching platform. According to the document teaching and learning are asynchronous, however it does not describe the advantages of the present invention with respect to asynchronous feedback.

CN106485967A describes an online teaching platform. The platform supports live broadcasts and recorded broadcasts, students can watch the video repeatedly when they encounter difficulties, and asynchronous teaching and learning is performed, however, the advantageous features of the present invention are not described.

US2016148522A1 describes an electronic education system to enable an interactive learning session. The electronic education system includes one or more devices for students and one device for instructors. The instructor device includes a monitoring module that allows the instructor to monitor the interactive learning session in a synchronous mode and in asynchronous mode, on one or more student devices, however, the special features of the feedback of the present invention are not mentioned.

CN109658772A describes a method of evaluation and surgical training based on virtual reality. The surgical training and evaluation method is implemented through a database module and execution modules. However, this document does not describe the characteristics of asynchronous feedback.

US2019201744A1 describes a system for body training or fitness services that includes an application that runs on an Internet-based network in which various mobile devices used by coaches and trainees communicate with a computer server. AIthough this document describes in a very general way the teaching of a movement through asynchronous and remote learning, said document does not describe that the system is capable of detecting and transferring delicate and meticulous manual skills, unlike the system of the present invention.

As seen in the documents mentioned above, there is none that discloses all and each of the characteristics of the system described in the present invention, that is: system or methodology of training with personalized, effective, asynchronous and remote feedback, this system being constituted by the following components: (1) a student module; (b) a storage module; (c) a control module; and (d) an evaluator module.

It should also be noted that, although the state of the art disseminates some systems of teaching manual skills, none discloses a feedback system that has the same characteristics as the system described here. To achieve adequate feedback, the evaluation module comprises a series of options that allow a teaching user or teaching users to deliver adequate feedback at the moment it detects the error of the student user. This feedback has the option of being incorporated at the exact moment, or not, when the teacher or teachers detect an error in the video of the students and is given in the format of insertion of videos of examples (how to fix the detected error, or how to point out the error to make it explicit), drawings (on the video), texts (on the video or separately), audios, among others, which allows the efficient improvement of the learning process of any skill.

### SUMMARY

The present invention is a system that facilitates the transfer of skills from a user or groups of users with the profile of teacher(s) or evaluator(s) or expert(s) to a user or group of users with pupil(s) or apprentice(s) or student(s) profile, remotely and asynchronously, allowing learner users or students to acquire competencies by achieving impressive learning curves thanks to the feedback of the experts(s) and subsequent correction of the errors as they occur.

The system is composed of four parts: (a) a student user module; (b) storage module; (c) a control module; and (d) evaluator module.

### BRIEF DESCRIPTION OF THE DRAWINGS

FIG. 1: This figure shows the overall architecture of the system with its three main components: mobile application, web application and Cloud BaaS (CBaaS).

FIG. 2A: This figure shows a flow diagram for creating/editing a course in accordance with the invention.

FIG. 2B: This figure shows a flow diagram for creating/editing an exercise in accordance with the invention.

FIG. 2C: This figure shows a flow diagram for viewing an exercise in accordance with the invention.

FIG. 2D: This figure shows a flow diagram for evaluating an exercise in accordance with the invention.

FIG. 2E: This figure shows a flow diagram for viewing an evaluation in accordance with the invention.

FIG. 3A: This figure illustrates a representative embodiment of the systems of the invention and an example of an interface for creating a new course.

FIG. 3B: This figure illustrates a representative embodiment of the systems of the invention and an example of a student or admin recording their performance for a specific exercise.

FIG. 3C: This figure illustrates a representative embodiment of the systems of the invention and an example of an interface for evaluation and feedback.

FIG. 3D: This figure illustrates a representative embodiment of the systems of the invention and an example of an assessment of a teacher.

FIG. 4A: This figure shows an exemplary embodiment of use cases in accordance with the invention and an example of a course use case.

FIG. 4B: This figure shows an exemplary embodiment of use cases in accordance with the invention and an example of creating/editing an exercise use case.

FIG. 4C: This figure shows an exemplary embodiment of use cases in accordance with the invention and an example of a course use case.

FIG. 4D: This figure shows an exemplary embodiment of use cases in accordance with the invention and an example of an exercise evaluation use case.

FIG. 4E: This figure shows an exemplary embodiment of use cases in accordance with the invention and an example of feedback (drawing, audio, text, video, and common mistakes) management.

FIG. 4F: This figure shows an exemplary embodiment of use cases in accordance with the invention and an example of a viewing evaluation.

### DETAILED DESCRIPTION

The present invention is a system that facilitates the transfer of skills from a user or groups of users with the profile of teacher(s) or educator(s) or evaluator(s) or expert(s) to a user or group of users with profile student(s) or apprentice(s) or student(s), remotely and asynchronously, allowing learner users or students to acquire competencies reaching impressive learning curves thanks to the digital feedback of the experts(s) and subsequent correction of the errors as they occur.

It must be understood that in the context of the present invention, when a reference is made to teacher(s) or educator(s) or evaluator(s) or expert(s), those terms are to be considered interchangeable. AIso, when a reference is made to student(s) or apprentice(s) or pupil(s) or trainee(s) or learner(s), are to be considered interchangeable.

The system includes five elements:
(a) a student module;
(b) storage module;
(c) a control module;
(d) administrator module; and
(e) evaluator or teacher module.

The different elements that are part of the system work as follows:

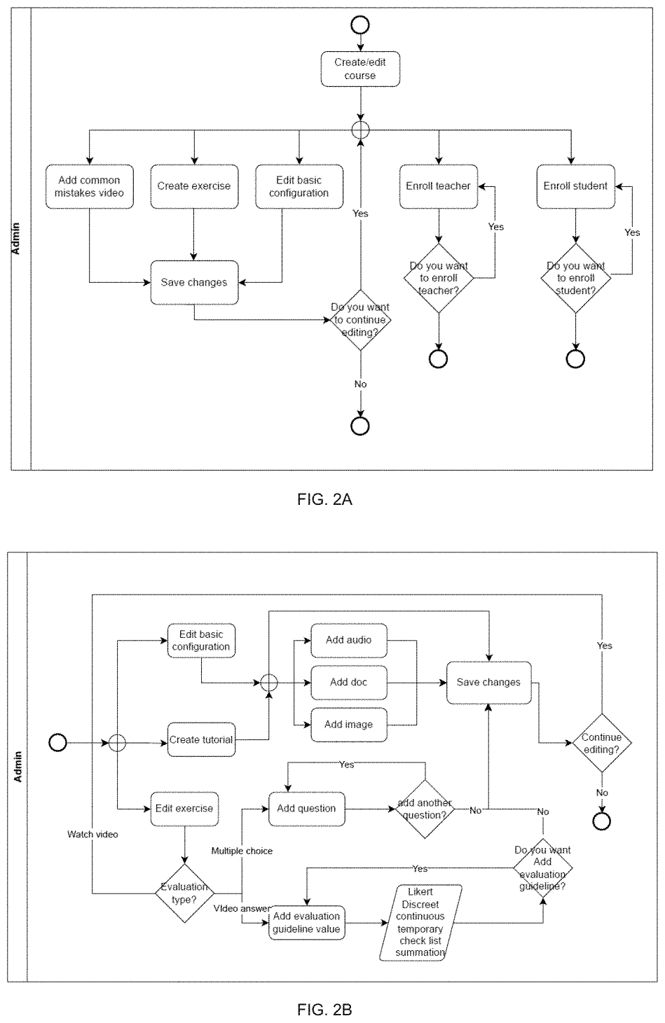

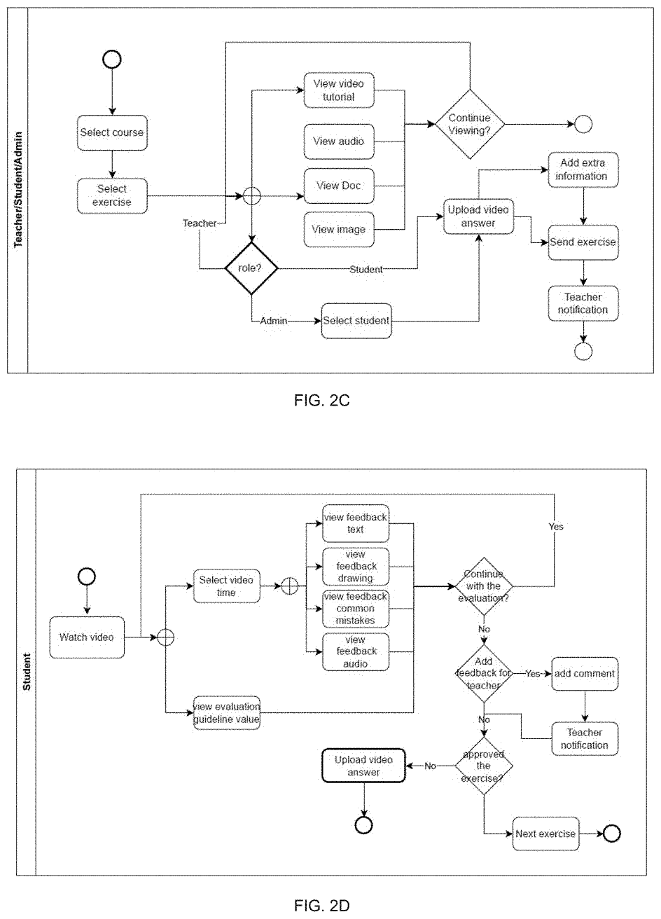

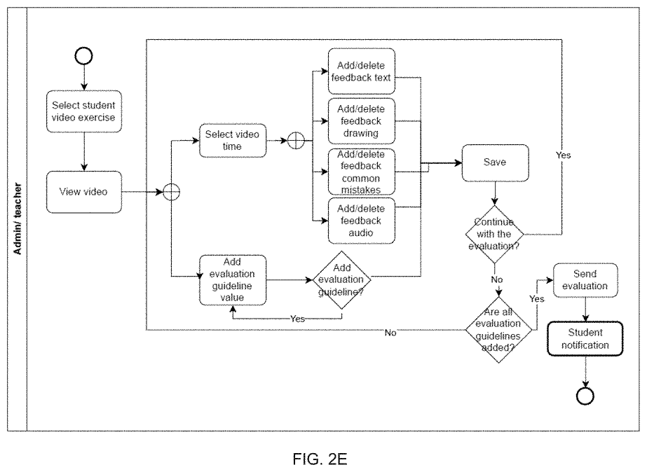

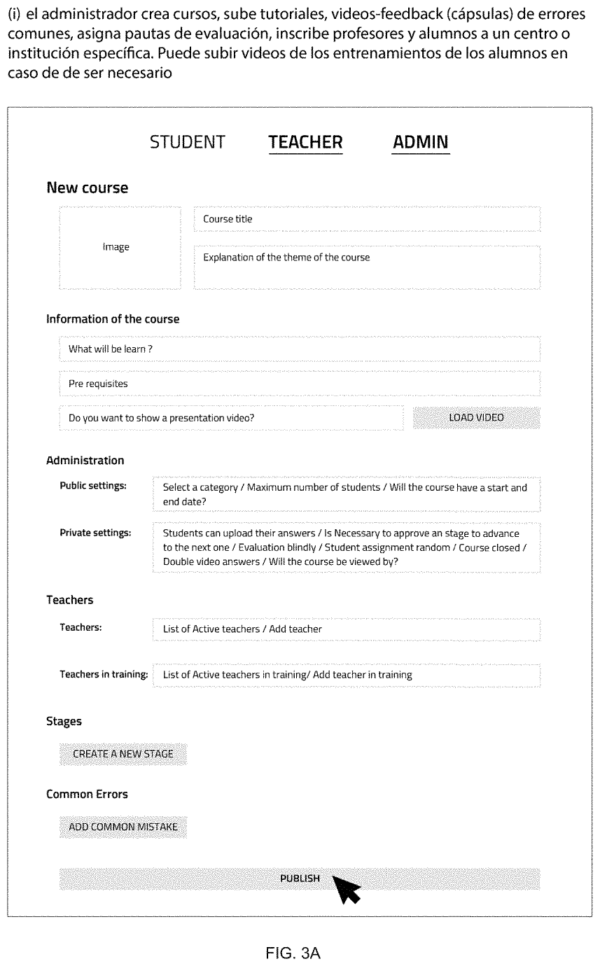

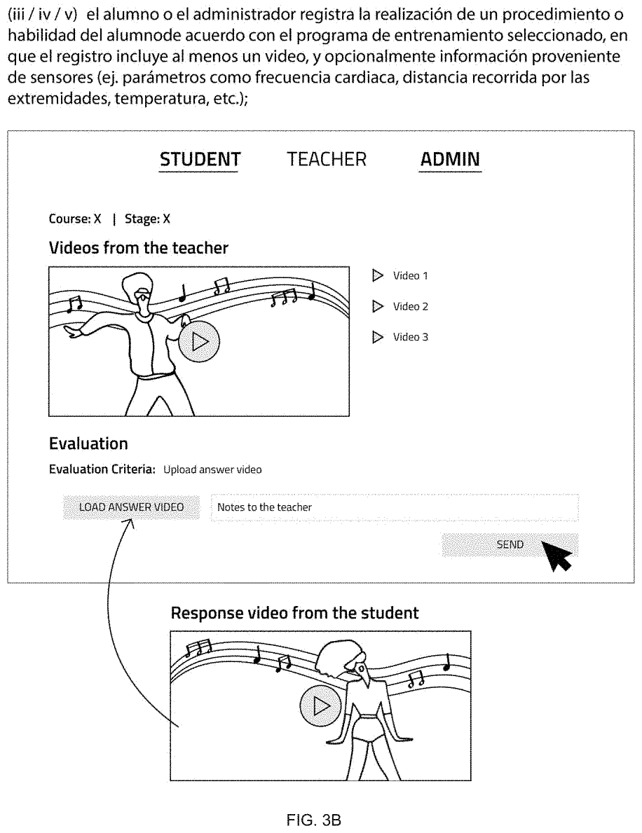

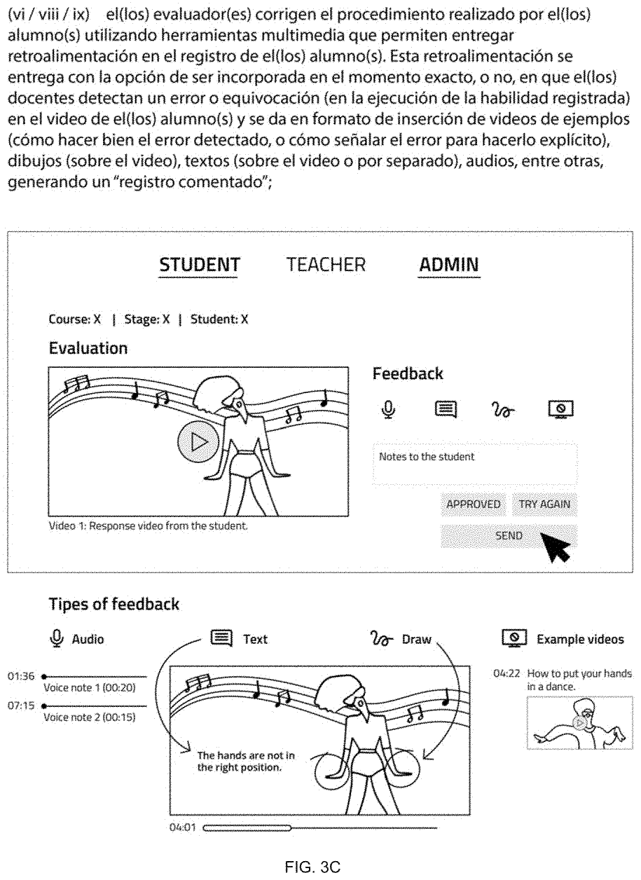

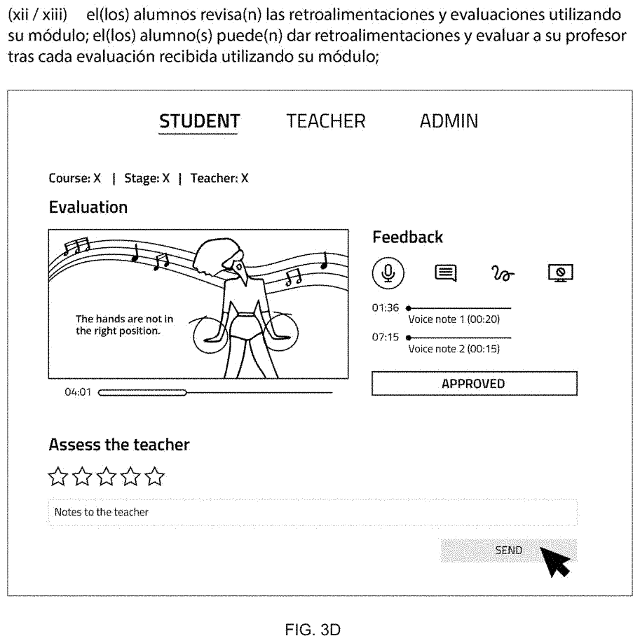

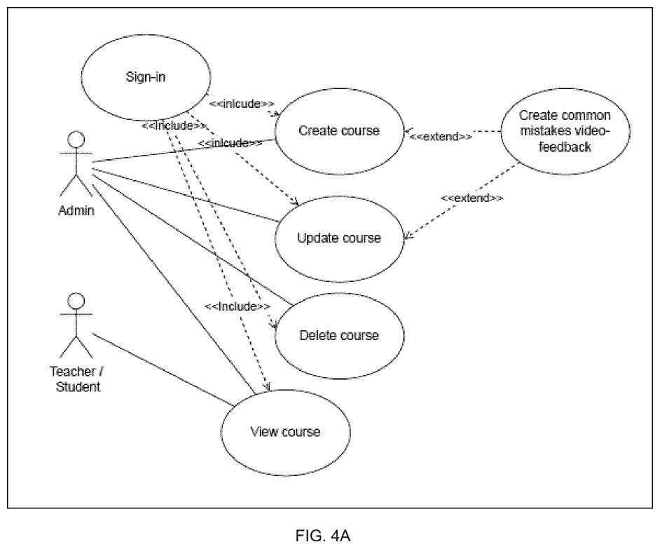

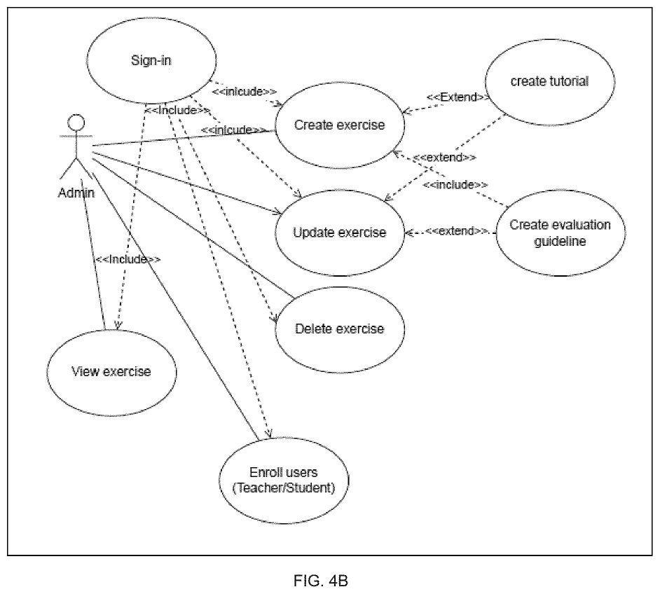

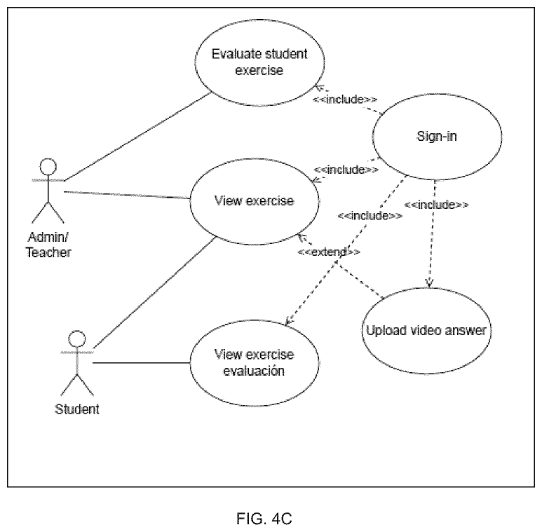

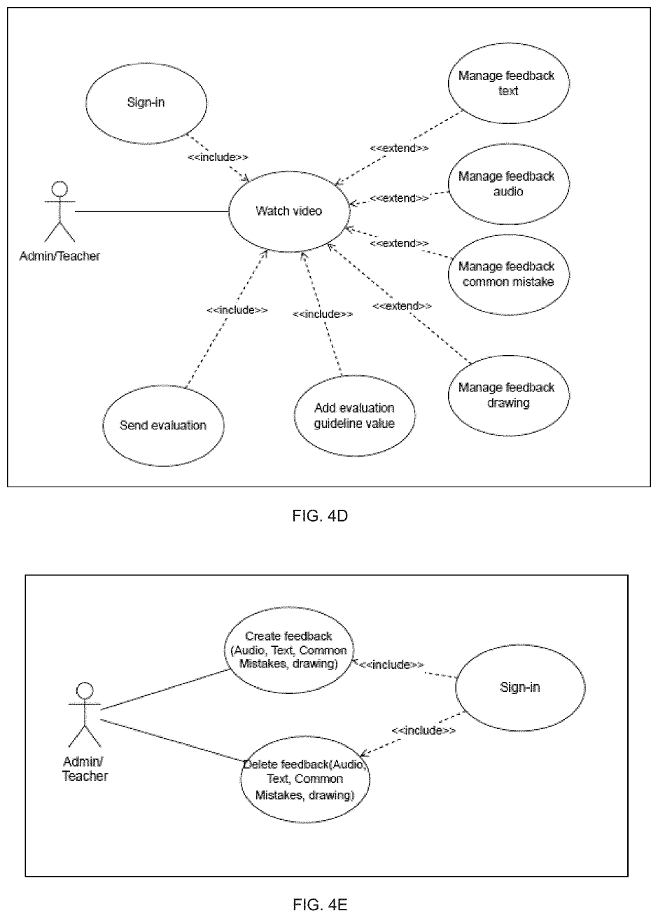

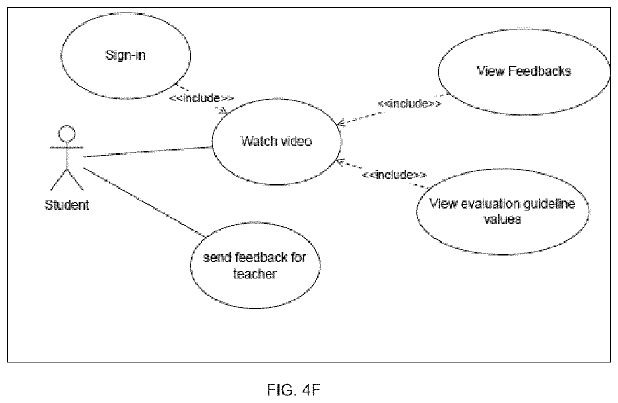

(i) the administrator creates courses, uploads tutorials, video-feedback (capsules) of common mistakes, assigns evaluation guidelines, enrolls teachers and students to a specific center or institution. Admin can upload videos of the students' trainings if necessary (FIGS. 2A, 2B, 3A, 3B, 4A, 4B);
(ii) the student selects the training or exercise program he wishes to perform from options available in the student's module (FIGS. 2C, 3C);
(iii) the student or the administrator records the performance of a procedure or skill of the student according to the selected training program, in which the record includes at least one video, and optionally information from sensors (e.g. parameters such as heart rate, distance traveled by the limbs, temperature, etc.) (FIGS. 2D, 3B, 4C);
(iv) the student or the administrator uploads the record to the storage module (FIG. 2D);
(v) the storage module compresses and maintains copies of the record made by the student;
(vi) the record is processed for motion pattern recognition and evaluation;
(vii) the control module takes the data from the register and distributes it to the evaluator(s); in the same way, it is in charge of centrally managing the different administrators for different institutions and courses.
(viii) the evaluator(s) correct the procedure performed by the student(s) using multimedia tools that allow feedback to be delivered in the student's record. This feedback is delivered with the option of being incorporated at the exact moment, or not, when the teacher(s) detect an error or mistake (in the execution of the registered skill) in the video of the student(s) and is given in the format of insertion of videos of examples (how to do the detected error correctly, or how to point out the error to make it explicit), drawings (on the video), texts (on the video or separately), audios, among others, generating a “commented record” (FIGS. 2E, 3C, 4D);
(ix) the evaluator(s) upload the commented record to the storage module. The storage module saves the commented record with feedback, timestamps and evaluations (FIG. 4E);
(x) the teacher's results are compared with the result obtained with image analysis with artificial intelligence and the evaluation is confirmed;
(xi) the control module distributes the assessments to the learner(s) or learner(s); (xii) students review feedback and assessments using their module (FIGS. 2D, 4F);
(xiii) the student(s) can give feedback and evaluate their teacher after each evaluation received using their module (FIGS. 3E, 4F);
(xiv) if the student passes he can move on to another exercise, but if he fails he must continue with the execution of the exercise, taking into consideration the recommendations made by the evaluators in the feedback, iterating the procedure until achieving the skill required to approve the training or exercise program.

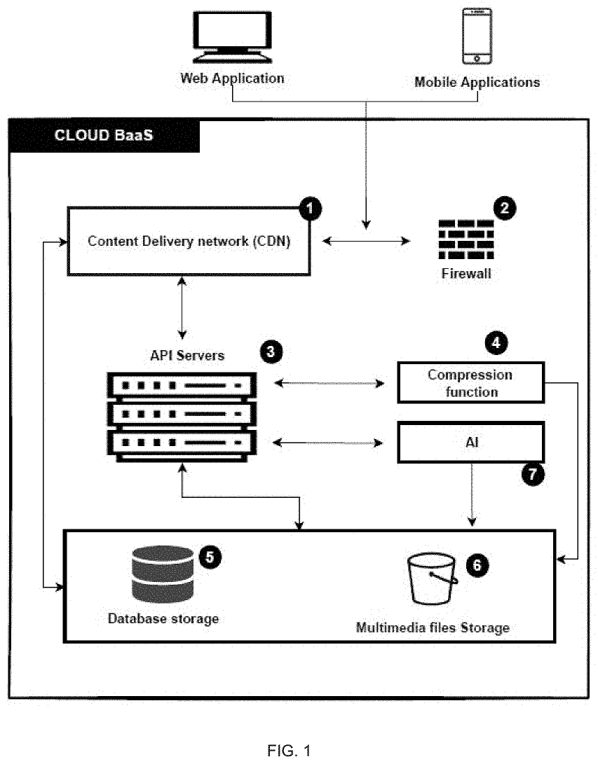

An exemplary flow chart is shown in FIG. 1 representing the different elements and their interaction for the system of the invention to work.

The components numbered in this figure are shown in the Table 1 below.

TABLE 1

| Components | Description |
|---|---|
| 1. Content delivery network (CDN) | Performs content caching and |
| | distribution of resources in different |
| | geographical areas with |
| | low latency. |
| 2. Firewall | It allows to protection of the main |
| | attacks carried out on the systems. |
| 3. API servers | Servers that deploy the REST API |
| | where the business logic runs |
| 4. Compression function | Function in charge of compressing |
| | the videos of different formats |
| 5. Database storage | It is responsible for storing all the |
| | data records of the system |
| 6. Multimedia files storage | Used for the storage of resources, |
| | among these are storage of |
| | multimedia files and web resources. |
| 7. AI | Artificial intelligence that is used to |
| | compare the result obtained with an |
| | image analysis algorithm to |
| | determine patterns in the exercise |
| | performed |

In a specific case, the processing carried out in step (vi) is carried out using equipment equipped with artificial intelligence for image analysis with convolutional neural networks.

In addition to the feedback, in point (ix), the teacher(s) can measure times (duration of the procedure or the registered skill or time fragments) and add an evaluation or performance grade based on comparison guidelines that the evaluator(s) previously loaded in the evaluation module. The guidelines can be created according to the preferences of the course administrator (such as dichotomous, discrete, nominal, continuous, etc.).

In a particular embodiment, the student's module comprises at least the following elements:
i) devices for training session recording;
ii) devices connecting to the storage module;
iii) information deployment device;
iv) theoretical assessment modules; and
v) gamification approach to training

In a more specific embodiment, the student module can be installed on mobile devices with video recording and viewing capabilities, such as smartphones and tablets, for example. Each of the students is registered in the system and can interact with their teachers. A student user can be a teacher of the skill he/she is learning or that he/she learned, if he/she is enabled by his teacher as a “student assistant” and for this he/she must change to a teaching module and thus help teachers to evaluate one or more students. The peer feedback modality is also added, where groups of two or more students can help evaluate and give feedback to other students using the teaching module.

In another embodiment, the control module corresponds to a computer that performs all the necessary actions for the system to work.

The control module is communicatively coupled to mobile devices and the storage module.

In another embodiment, the main function of the administrator module is to add and distribute teachers, allow teaching users to design personalized courses and exercises, with multiple evaluation guidelines, as well as evaluating the performance of students or apprentices. Additionally, the control module and the administrator module function as an analysis and “learning analytics” center, where all performance is monitored per student or per group of students to maintain high standards of learning and teaching quality using tracking data. Such data, such as video viewing time, browsing time, number of feedback views, user journey through the different stages, number of feedbacks and teacher quality evaluations, among others, raise learning alerts to maintain the orientation of students towards a homogeneous group of achievements with data reporting for educational decision making. The control module allows communication between administrators and end users.

In another embodiment, the student module includes a screen interface for navigating throughout the course content.

In another embodiment, the storage module corresponds to any hardware or service in the cloud that allows the saving of the information of each student. More specifically, the previously mentioned modules or devices requires a specific configuration of the hardware, memory interactions, or processing power, thus allowing faster responsiveness of the system, and therefore providing a smooth experience in the interaction between either teacher(s) or pupil(s). The servers of this invention include specific configurations of algorithms in the machine learning cloud to ensure a progressive analysis of the learning experience. The data is under high-level security and encryption standards, based on HIPAA compliance recommendations for the management, protection, and distribution of sensitive data in the field of health. These standards extend technically and organizationally.

In another embodiment, the evaluation or teaching module comprises at least the following elements:
(i) devices connecting to the storage module;
(ii) display interface;
(iii) logging devices;
(iv) video editing interface

It must be emphasized the specific interoperability of the different hardware components used in the system of the invention. For example, the communication or interoperability between either training session recording devices that must be coordinated with all different sensors to provide an accurate mark allowing precise revision of teacher(s) comments. Specifically, the interaction of the different components of the system of the invention transforms a set of different files that contain essential information regarding the operation of the system. For example, any action performed by the pupil(s) will impact in the sensors, recording devices, display interfaces, storage modules, information deployment device, or theoretical assessment modules. More importantly, it must be emphasized that the system of the invention cannot work as an automatic independent system, since all data processing, interactions between modules, etc. requires at least one minimum interaction with a pupil(s) or teacher(s) which modifies at least one file maintained in the storage module. Thus, any interaction with a human user will produce a modification in the interaction between the different components of the system, as well as will modify the files containing all the information required for the system to work.

Therefore, the present invention cannot be conducted without a specific and sophisticated hardware system. Furthermore, motion pattern recognition requires advanced computer programs and computing power to achieve this, as well as AI evaluation of the teacher's results with the result obtained with image analysis.

In a specific embodiment, the evaluator module includes a visualization interface that allows the teacher to design a personalized exercise session, selecting from a variety of options, including, but not limited to, a prescription of the categorized video files that show demonstrative movements that are stored in the storage module.

In a specific embodiment, the video editing interface of the evaluator module has a series of tools to perform the evaluation of the exercises. The possible features contained in this module are video function, text function, graphics function, voice recording function, use of comparison patterns with discrete or continuous variables created in control module, video libraries, creation of favorite comment libraries, video sharing functions, comments of multiple collaborative evaluators, editing tools, creation of stickers and gamification elements in educational environments.

The AI system aims to identify the movement patterns of exercise videos and determine an exercise's execution time, mistakes made, and approval based on those two criteria. The first phase recognizes movement patterns, while the second phase is oriented to the analysis of text, audio, drawing and videos of common errors as a feedback recommender system.

AIthough one or more embodiments of the present invention have been illustrated above, the expert in the art will appreciate that modifications and adoptions can be made to those embodiments without departing from the scope and spirit of the present invention.

### Examples

### Example 1. System Architecture

The architecture of this system includes elements of Cloud Computing and mobile platforms, taking advantage of Mobile Cloud Computing. This architecture has a mobile component, which connects through an internet connection with another component in the cloud.

We chose an application that can be used on mobile devices that allows correct asynchronous learning, combining classic components of a Learning Management System (LMS), with additional tools for the delivery of continuous feedback. This system gives students the possibility to receive comments on their performance as, or better than, in the face-to-face formats, and in turn ensures the persistence of this information, able to be reviewed as often as the student requires. FIG. 1 shows the overall architecture of the system with its three main components: mobile application, web application and Cloud BaaS (CBaaS).

The first component is the mobile app. Corresponding to the application installed on the mobile devices of the students. Since its function is to provide easy access to feedback, it cannot be restricted to a particular mobile operating system, opting for the use of a cross-platform paradigm. This allows for a single development, rather than specific developments with different languages and frameworks. The platform chosen was React Native, a native scripting framework. This technology generates native applications with an interpreter that processes JavaScript code at run time. In addition, it provides the possibility of making calls to native APIs, allowing all the specific functions for each platform. AIthough small losses in performance are generated compared to native applications, the application to be developed does not have functionalities that require great computing power on the device, so it is not a relevant disadvantage. This framework is based on a component model proposed by React, providing facilities for the development of views and high compatibility with the second component, the web application.

The web application is the component that is used by: teachers, to deliver feedback to students; administrators, to upload student assessments; and super administrators, to control the content of the courses. Its development was carried out with the React interface library. Its choice is based on its high performance compared to existing alternatives, and it shares the same foundation as React Native. The performance achieved is due to the use of the Virtual DOM, which uses JavaScript to calculate the states of the interfaces, and thus determine when the visualizations should be modified. On the other hand, by sharing the same component base with React Native, it allows you to decrease learning curves and reuse code.

Both components interact with a CBaaS, the third relevant component of the system. They communicate using HTTPS requests for the secure transmission of information, following the specifications proposed by Facebook of GraphQL. In conjunction with its implementation, it allows for the defining of the required information, obtaining in just one call the precise information. Thanks to this, it is possible to minimize the number of interactions and the size of information transmitted, reducing possible connectivity problems, and reducing the waiting time for the display of information.

The last component, CBaaS, is responsible for processing the information and ensuring its persistence over time. It uses Apollo GraphQL, a NodeJS implementation of the GraphQL specifications. In addition, it implements a microservices architecture, which allows the separation of business logic into independent pieces. This architecture delivers multiple advantages, highlighting that of being able to be tested and scaled independently. The AI system to support the evaluator is composed of a set of neural network architectures oriented to the following functions:

Detection of objects, containers, and pins:

This model is a three-class object detector (object, vessel, pin) based on the YOLO V4 architecture. With this, the best solution for the spatial detection of these classes was achieved

In the current state of the model, an accuracy of 98% has been achieved for the location of the determined classes.

Location of arms and holding area:

In this objective it is not only necessary to detect the spatial position of these elements, but their own shape, which is why a segmentation model based on U-NET was implemented with RESNET 18 as an encoder:

For the training and deployment of the models, Python has been used as a programming language along with the implementation of Pytorch as a library for the use of Deep Learning. For its operation in GPUs, the CUDA and CUDNN drivers have been used.

Progress query:

In this process a MULTIPART FORM DATA is expected with the unique code of the previously loaded video, in this the state of the work on it will be returned (In queue, in progress, finished). If it is complete, the data collected from the video (Start, end, falls) will be returned within the JSON.

The mobile application is the main tool of the student to improve their learning, allowing a linear asynchronous training, that is, they can perform the trainings at their own pace, but following a study plan indicated by the system. The student must pass stages to be able to access the most complex exercises, counting on unlimited attempts to pass them. For this, a section of tutorial videos is presented where the student can review the indications for the exercises (FIG. 2A). On the other hand, there is the evaluations section. Its objective is to be able to provide the student with the videos of the evaluated exercises. In this you can play each evaluation while reviewing the feedback delivered in text, audio, drawing format (FIGS. 2B and 2C), as well as watch videos of common errors with their respective corrections. AIl these adjuncts are made by an expert, delivering an experience similar to face-to-face interactions with teachers. After each evaluation, the student must evaluate his teacher, allowing the teacher to improve in the quality of feedback delivered.

The web application is used by students, administrators, and teachers. Administrators will be able to perform different actions, such as modifying course content and uploading videos of student assessments. This information is what students will have access to on their mobile devices, sending the updated content each time it is requested.

Teachers will have the necessary tools to evaluate and deliver feedback to students, establishing a direct interaction with the student. Not only will they allow you to deliver comments as if they were in person, but they will also provide the student with the option to see it at the time you want and an indeterminate number of times. To each evaluation you can attach texts, audios, and drawings (FIG. 3), as well as videos of common errors previously prepared that are on the platform or generated by the same teacher.

In addition to this, the teacher can assign scores as appropriate to the evaluation scale of the exercise and decide if the student passes. To pass, you must meet established minimum requirements, which can be duration or score. In the same way, the evaluation goes through the AI system that confirms the data entered by the evaluator while progressively training the algorithm.

To allow a correct integration of the first two components, a customized Backend as a Service cloud solution is proposed. BaaS allows complex connections to be established with little configuration, and solves major problems in mobile development, such as: user authentication, Push Notifications, storage of large resources, analytics, among others. To do this, it was decided to combine services delivered by Amazon Web Services (AWS) and Firebase.

The students who will access the platform will have different temporal space contexts, among others, so the system must ensure centralized access, as well as consistency and persistence of information. To meet these requirements commonly required by Mobile Cloud Computing systems, AWS services are used to maintain information and audio-visual content. For the information, a PostgreSQL relational database is used, which ensures the ACID properties (atomicity, consistency, isolation, durability), very relevant for the information of the courses and evaluations. Audio-visual content is delivered via S3 and CloudFront, with the responsibilities of storing files and speeding up access to them via cache respectively.

### Example 2. Training of Surgeons with the System of Invention

In order to compare the present invention with respect to face-to-face and remote training methodologies, two quasi-experiments were performed which are detailed below.

The first quasi-experiment (Q1) consisted of performing a series of 10 exercises with increasing difficulty, aimed at improving basic laparoscopy skills. Participants are divided into two groups. One of them would receive feedback in person, and the other remotely using the system of the present invention. Both groups were evaluated with the procedure times in a correct performance, where the seconds indicated in Table 2 are established as the cut-off point of approval.

TABLE 2

| Activity | Maximum time to pass (seconds) |
|---|---|
| Fall of the bean | 24 |
| String displacement | 28 |
| Figure board | 68 |
| Block movement | 16 |
| Silicone suture | 17 |
| Interrupted intracorporeal suture | 90 |
| Continuous intracorporeal suture | 270 |
| Gauze cutting | 98 |
| Endoloop | 53 |
| Laparoscopic Cannulation | 65 |

The second (Q2) consisted of conducting an optional survey of students who used the invention system. This survey was designed to measure criteria of usability and acceptance of the platform.

A total of 420 participants were reached. The group that received face-to-face feedback had 288 students, and 132 participants obtained it remotely. It should be noted that the 20 exercises were only completed by 169 students, 130 of the face-to-face and 39 of the remote. Of the students who used the present invention, 32 answered the usability survey.

For the quasi-experiment Q1, 10 different exercises were performed. These had incremental difficulty and were designed to develop different motor skills required in laparoscopy. For evaluation, two criteria were used: compliance with the exercise (the student completed the exercise correctly), and the duration (the student completed the exercise in less time than the maximum defined).

For the Q2 quasi-experiment, 14 usability questions were asked using the Likert scale. This survey was applied within the mobile application.

For the analysis of data that allowed SP1 to respond, the main results of Q1 were analyzed for those who completed all the exercises. This is the comparison of the execution times obtained in each of the evaluations, for both formats (face-to-face feedback and remote feedback). AIl times were measured in seconds.

Results

The results are presented around two research sub-questions:

(SP1) Can students gain the skills needed to pass the course with remote feedback, as well as with face-to-face feedback?

60% of the participants did not complete all the evaluations (54% of the face-to-face and 70% of the remote ones), having left the course or to date they continue with pending evaluations. The evaluations considered the first of each student in each exercise; and each approved student in each exercise.

Both the group with remote and face-to-face feedback presented significant differences in the first evaluation with the approved one. In addition, 100% of the students managed to pass the course. That is, all the participants managed to cross the cut-off point.

In the comparison of both feedback methods in their approved evaluation, there were no significant differences in most of the exercises, only in: Displacement of the rope, Interrupted intracorporeal suture and Gauze cutting. The details of the results can be seen in Table 3.

TABLE 3
Results first question sub-research.

| | | | | | | | | | | | | | | | First | |
|---|---|---|---|---|---|---|---|---|---|---|---|---|---|---|---|---|
| | | | | | | | | | | | | | Face-to- | | attempt: | Approved: |
| | | | | | | | | | | | | | face: | Remote: | Face-to- | Face-to- |
| | FIRST | | | FIRST | | | APPROVED | | | REMOTE | | | First v/s | First v/s | face v/s | face v/s |
| | FACE-TO-FACE | | | REMOTE | | | FACE-TO-FACE | | | APPROVED | | | Approved | Approved | Remote | Remote |
| | Min | Max | Med | Min | Max | Med | Min | Max | Med | Min | Max | Med | P | P | P | P |
| Fall of the | 26 | 183 | 61.5 | 21.6 | 112 | 45 | 15 | 24 | 20 | 15 | 24 | 20 | 0.0001 | 0.0001 | 0.0001 | 0.2753 |
| bean | | | | | | | | | | | | | | | | |
| Rope | 27 | 115 | 45.5 | 16.8 | 86 | 41.3 | 11 | 27 | 20 | 15 | 27 | 23 | 0.0001 | 0.0001 | 0.1619 | 0.0006 |
| Displacement | | | | | | | | | | | | | | | | |
| Figure board | 49 | 288 | 127 | 46 | 193.9 | 102 | 32 | 68 | 53 | 35 | 63 | 55 | 0.0001 | 0.0001 | 0.0001 | 0.363 |
| Block | 16 | 154 | 46.5 | 17 | 81.6 | 41 | 11 | 16 | 14 | 11 | 16 | 14 | 0.0001 | 0.0001 | 0.0056 | 0.2676 |
| movement | | | | | | | | | | | | | | | | |
| Silicone | 25 | 243 | 75 | 15.9 | 187.6 | 66.6 | 11 | 17 | 15 | 10.7 | 17 | 15.2 | 0.0001 | 0.0001 | 0.1888 | 0.1294 |
| suture | | | | | | | | | | | | | | | | |
| Interrupted | 65 | 494 | 181.5 | 58 | 415 | 101.8 | 46 | 90 | 71 | 52 | 85 | 68 | 0.0001 | 0.0001 | 0.0001 | 0.0289 |
| intra- | | | | | | | | | | | | | | | | |
| corporeal | | | | | | | | | | | | | | | | |
| suture | | | | | | | | | | | | | | | | |
| Continuous | 210 | 1500 | 453.5 | 1.672 | 754.5 | 323.4 | 165 | 270 | 217 | 133 | 267.1 | 223.1 | 0.0001 | 0.0001 | 0.0001 | 0.1334 |
| intra- | | | | | | | | | | | | | | | | |
| corporeal | | | | | | | | | | | | | | | | |
| suture | | | | | | | | | | | | | | | | |
| Gauze cutting | 60 | 409 | 136.5 | 75 | 394.8 | 125 | 42 | 96 | 73 | 52 | 93 | 80 | 0.0001 | 0.0001 | 0.3366 | 0.0042 |
| Endoloop | 20 | 184 | 54 | 18.5 | 104.6 | 38 | 13 | 53 | 31 | 16.2 | 41.2 | 30 | 0.0001 | 0.0001 | 0.0001 | 0.974 |
| Laparoscopic | 20 | 327 | 89.5 | 12 | 123 | 39 | 15 | 62 | 34 | 11 | 54 | 29 | 0.0001 | 0.0007 | 0.0001 | 0.0727 |
| Cannulation | | | | | | | | | | | | | | | | |

SP2) Does the platform complicate students' interaction with the course?

A total of 32 responses were obtained in the applied usability survey, which corresponds to 82% of the possible participants (remote group). In this, as shown in Table 4, you can see that the results are positive. In general, users responded that they agree that the platform has good usability, however, there are users who declare having had problems in navigation, and with some inconsistencies.

TABLE 4
Results second question sub-research.

| | P25 | MEDIAN | P75 |
|---|---|---|---|
| Overall, I am satisfied with the | 2 | 4 | 4.25 |
| ease in which I was able | | | |
| to use the platform | | | |
| Overall I am satisfied with the | 3 | 4 | 5 |
| time it took me to use the App | | | |
| Overall, I am satisfied with the | 4 | 4 | 5 |
| instructions and supporting | | | |
| information | | | |
| It's easy to navigate the app | 3 | 4 | 5 |
| The app is nice | 3 | 4 | 5 |
| The app has a clean and simple | 4 | 4 | 5 |
| presentation | | | |
| I think I would like to use this | 3 | 4 | 5 |
| system frequently | | | |
| I find the platform unnecessarily | 1 | 2 | 2 |
| complex | | | |
| I think I would need someone | 1 | 2 | 3 |
| else's technical support to | | | |
| be able to use the platform | | | |
| I think all the functions of the | 2.75 | 4 | 4 |
| platform in this system | | | |
| were well integrated | | | |
| I think there was a lot of | 2 | 2 | 3.25 |
| inconsistency on the platform. | | | |
| I think most people would learn | 4 | 4 | 4 |
| to use this platform pretty | | | |
| quickly. | | | |
| I found the platform quite | 2 | 2 | 4 |
| awkward to use | | | |
| I felt safe using the platform | 3 | 4 | 5 |

### CONCLUSIONS

The results of the first quasi-experiment indicate that there are significant differences between the first evaluation and the approved evaluation of the students using the present invention, fully complying with the established educational requirement: to pass the course. However, when comparing this group with those who took the course in the traditional format, no significant differences were found in most of the exercises, so the efficiency of this invention is comparable to learning in face-to-face mode.

On the other hand, from the results we can see that most of the ranges of exercise times are lower for the students who used the present invention. This indicates that although better times are not obtained than in the face-to-face method, more standard results are obtained, leading to the students finishing with a similar base in the course.

For the second quasi-experiment, we can see that there is a good acceptance of the platform, with good usability scores. This result indicates that the platform fulfills the premise of not complicating the learning experience. In addition, we can conclude that the use of the selected technologies did not adversely affect users.

### INDUSTRIAL APPLICATION

The present invention has application in the education sector. In particular, the present invention has been described with a particular focus on the medical area, without this implying a waiver by the applicant of the other applications that the invention may have.

We claim:

1. A training system with personalized, effective, asynchronous, and remote feedback, the system comprising five elements:
a. a student module;
b. storage module;
c. a control module;
d. administrator module; and
e. evaluator or teacher module.

2. The training system according to claim 1, wherein an administrator, a student or an evaluator interact with the elements of the system.

3. The training system according to claim 2, wherein the administrator creates courses, uploads tutorials, video-feedback (capsules) of common mistakes, assigns evaluation guidelines, enrolls teachers and students to a specific center or institution.

4. The training system according to claim 2, wherein the student selects the training or exercise program he/she wishes to perform from options available in the student's module, and wherein the student or the administrator records the performance of a procedure or skill of the student according to the selected training program, in which the record includes at least one video, and optionally information from sensors.

5. The training system according to claim 3, wherein the student or the administrator uploads the record to the storage module, wherein the storage module compresses and maintains copies of the record made by the student, generating a register.

6. The training system according to claim 4, wherein the record is processed for motion pattern recognition and evaluation.

7. The training system according to claim 5, wherein the control module takes the data from the register and distributes it to the evaluator(s); in the same way, the control module is in charge of centrally managing the different administrators for different institutions and courses.

8. The training system according to claim 7, wherein the evaluator(s) correct the procedure performed by the student(s) using multimedia tools that allow feedback to be delivered in the student's record, and wherein this feedback is delivered with the option of being incorporated at the exact moment, or not, when the teacher(s) detect an error or mistake during the execution of the registered skill in the video of the student(s) and is given in the format of insertion of videos of examples showing how to do the detected error correctly, or how to point out the error to make it explicit, drawings (on the video), texts (on the video or separately), audios, among others, generating a “commented record”, and wherein the evaluator(s) uploads the commented record to the storage module, saving also the commented record with feedback, timestamps and evaluations.

9. The training system according to claim 8, wherein the evaluator's results are compared with the result obtained with image analysis with artificial intelligence and the evaluation is confirmed.

10. The training system according to claim 8, wherein the control module distributes the assessments to the student(s) who will review feedback and assessments using the student module.

11. The training system according to claim 9, wherein the student(s) can give feedback and evaluate their teacher after each evaluation received using the student module.

12. The training system according to claim 11, wherein if the student passes the exercise, he/she can move on to another exercise.

13. The training system according to claim 11, wherein if the student fails he/she must continue with the execution of the exercise, taking into consideration the recommendations made by the evaluators in the feedback, iterating the procedure described in claim 11 until achieving the skill required to approve the training or exercise program.

14. The training system according to claim 1, wherein the student's module comprises at least the following elements:
a. devices for training session recording;
b. devices connecting to the storage module;
c. information deployment device;
d. theoretical assessment modules; and
e. gamification approach to training

15. The training system according to claim 1, wherein the student's module can be installed on mobile devices with video recording and viewing capabilities, and wherein a screen interface for navigating throughout the course content.

16. The training system according to claim 1, wherein the control module corresponds to a computer that performs all the necessary actions for the system to work and is communicatively coupled to mobile devices and the storage module.

17. The training system according to claim 1, wherein the main function of the administrator module is to add and distribute teachers, allow teaching users to design personalized courses and exercises, with multiple evaluation guidelines, as well as evaluating the performance of students or apprentices.

18. The training system according to claim 1, wherein the control module allows communication between administrators and end users.

19. The training system according to claim 1, wherein the storage module corresponds to a specialized hardware or service in the cloud that allows the saving of the information of each student.

20. The training system according to claim 1, wherein the modules or devices requires a specific configuration of the hardware, memory interactions, or processing power, thus allowing faster responsiveness of the system, and therefore providing a smooth experience in the interaction between either teacher(s) or pupil(s).

21. The training system according to claim 1, wherein the evaluation or teaching module comprises at least the following elements: devices connecting to the storage module; display interface; logging devices; video editing interface

22. The training system according to claim 1, wherein the evaluator module includes a visualization interface that allows the teacher to design a personalized exercise session, selecting from a variety of options, including, but not limited to, a prescription of the categorized video files that show demonstrative movements that are stored in the storage module.

23. The training system according to claim 1, wherein the video editing interface of the evaluator module has a series of tools to perform the evaluation of the exercises, such as video function, text function, graphics function, voice recording function, use of comparison patterns with discrete or continuous variables created in control module, video libraries, creation of favorite comment libraries, video sharing functions, comments of multiple collaborative evaluators, editing tools, creation of stickers and gamification elements in educational environments.
